(19) United States
(12) Patent Application Publication
(10) Pub. No.: US 2015/0090140 A1
(43) Pub. Date: Apr. 2, 2015

(54) PRINT JOB AND PROCESS ROLL EVENT TRACKING

(71) Applicant: Goss International Americas Inc., Durham, NH (US)

(72) Inventors: Michael Raymond RANCOURT, Merrimack, NH (US); Howard W. HOFF, Lee, NH (US)

(73) Assignee: Goss International Americas Inc., Durham, NH (US)

(21) Appl. No.: 14/042,946

(22) Filed: Oct. 1, 2013

(51) Int. Cl. B41F 7/04; B41F 33/00

(52) U.S. Cl. CPC B41F 7/04; B41F 33/0009
USPC 101/219; 101/484

(57) ABSTRACT

A method and printing press for performing the method is provided for recording print processing conditions on a printed web of a rewind roll during operation of a printing press to print a print job, including associating sensed printing process parameters with tracked locations on the web at which the printing process parameters were sensed such that, for each tracked location, there is an associated set of printing process parameters; storing in memory, for each tracked location, the associated set of printing process parameters; and storing in memory an identification of the rewind roll, and an association of the rewind roll with the associated set of printing process parameters for each tracked location.

The present invention relates to the field of printing presses, and in particular to printing presses which are configured as roll to roll systems, which are typically used in packaging printing

### BACKGROUND

In a roll to roll printing press, for example, an offset web printing press, the web is typically run from a web roll through a printing section, a dryer, and a chill roll stand before being rewound as a printed rewind roll in a rewind unit. Multiple characteristics of the web may change throughout this process. These characteristics include registration, such as lateral, circumferential and plate cocking (skew), and print quality, including color density, dot gain, and contrast. Other characteristics may include repeat length, fan in/fan out and wetness or dryness of the printed ink.

In automatically controlled printing presses, for example, Omnicom™ controls and Omni Makeready™ available for the Goss Sunday® and Goss M600™, learning algorithms automatically adjust based on data from previous jobs and closed loop control allows full integration with the press controls to reduce response time and waste. The controller for the printing press is automatic and adjusts for a variety of characteristics without operator input.

U.S. Published Patent Application No. 2008/0196612, incorporated herein by reference, describes a real time print product status system which includes sensors located at various positions along a press line to detect characteristics of the web, including, for example color density, dot gain, contrast, lateral register, circumferential register, skew, cut-off, print-to-cut registration and folder head-to-tail spacing, wetness, and dryness. When defects are detected, they can be indicated in light poles located along the press line and in a graphical user interface

### SUMMARY OF THE INVENTION

In accordance with a first embodiment of the present invention, a method is provided for recording print processing conditions on a printed web of a rewind roll during operation of a printing press to print a print job. The method includes providing a web roll, the web roll containing an web; unwinding the web from the web roll and passing the web through a printing unit of the printing press; printing on the web with the printing unit as the web passes through the printing unit; passing the web through one or more further processing components to a rewind station located downstream of the downstream of the printing unit; and winding the printed web onto a rewind roll located at the rewind station.

Further, as the web passes through the one or more further processing components, the method further includes the steps of: tracking, with a position sensor, a plurality of equally spaced locations on the web; and detecting, using one or more sensors, a plurality printing process parameters of the printing press at a plurality of time points.

The method further includes associating the sensed printing process parameters with the tracked locations on the web at which the printing process parameters were sensed such that, for each tracked location, there is an associated set of printing process parameters; storing in memory, for each tracked location, the associated set of printing process parameters; and storing in memory an identification of the rewind roll, and an association of the rewind roll with the associated set of printing process parameters for each tracked location.

In accordance with a further aspect of this embodiment, the step of detecting may further comprise using a processor to process data from the one or more sensors to generate one or more of the plurality of printing process parameters.

In accordance with a yet further aspect of this embodiment the printing process parameters may include two or more of : a print defect selected from the group consisting of mark, spot, slime hole, and hickeys; optical density; registration; color deviation; scumming; lateral fit; and water mark. In this regard, the registration may include one or more of circumferential register, lateral register, and skew.

In accordance with yet another aspect of this embodiment, the printing process parameters may include a parameter which indicates whether or not a printed image on the web matches a master image.

In accordance with yet another aspect of this embodiment, the method may further comprising printing a scanable label, the scanable label having identification information uniquely identifying the rewind roll.

In accordance with yet another aspect of this embodiment, the method may further comprise: storing in memory, print job data associated with the print job; and storing in memory, an association of the print job data with the rewind roll. The print job data may, for example, include two or more of: dot gain; contrast; register deviation; optical density targets; optical density deviation limit; length of web on roll; substrate type; substrate modulus; substrate thickness; ink key preset metrics; print job repeat length, and unstrained repeat length.

In accordance with a second embodiment of the present invention, a printing press is provided. The printing press includes: a web roll which contains a web; an infeed configured and arranged to unwind the web from the web roll; a plurality of printing units configured and arranged to print on the web as the web passes through the printing units; a rewind station located downstream of the of the printing units, the rewind station configured and arrange to wind the web onto a rewind roll; and one or more further processing components located downstream of the printing units and upstream of the rewind station. The press also includes a position sensor configured and arranged to track a plurality of equally spaced locations on the web, and a controller connected to the infeed, the plurality of printing units, and the rewind station. The controller is configured and arranged to perform the method according to the first embodiment.

### BRIEF DESCRIPTION OF THE DRAWING

The present invention will be further described with respect the following FIGURE, in which:

FIG. 1 shows a system in accordance with an embodiment of the present invention.

### DETAILED DESCRIPTION

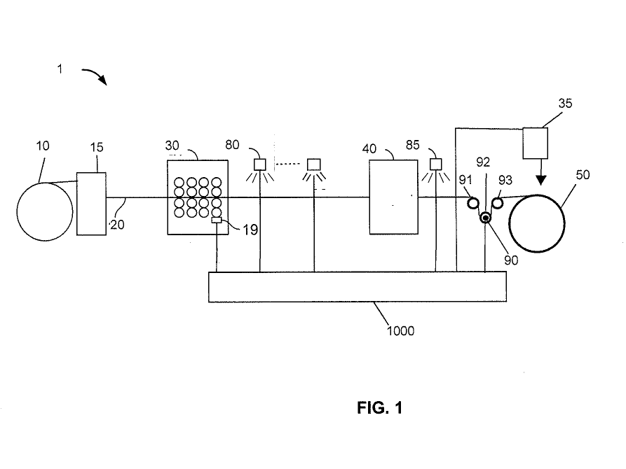

FIG. 1 shows an exemplary printing press 1 in accordance with an embodiment of the present invention. A substrate web 20 is unwound from an unwind roll 10 to infeed 15 and passed through printing units 30 which print onto web 20. After the printing units 30, the web passes through a number of further processing components 40 before being wound onto a rewind roll 50.

Each printing unit 20 can be a perfecting printing unit including an upper inker, upper dampener, upper plate cylinder, and upper blanket cylinder for printing on a top side of the web, and a lower inker, lower dampener, lower plate cylinder, and lower blanket cylinder for printing on a bottom side of the web. If the printing unit 20 is instead a non-perfecting unit, meaning that it prints on only one side of the web, then the lower inker, dampener, plate cylinder and blanket cylinder would be replaced with an impression cylinder. Downstream processing components 40 could, for example, include a dryer and a chill roll stand.

The rewind roll 50 is subsequently removed and transported or stored for later use. For example, in packaging applications, the rewind roll could later be used in packaging machinery to, for example, form cardboard boxes, or to wrap merchandize in printed plastic wrapping.

It is useful to have information regarding the printed web on the rewind roll. For example, it is desirable to know the location of any print defects or other deviations from desired parameters. It is also useful to know the print job settings.

In prior art techniques, a manual or semi-automated process was used to physically apply a flag or marker at various positions within the rewind roll. It is believed that only conditions detected by visual inspection (manual or automated) are presently associated to rewind roll position by manual or semi-automatic means.

These techniques are deficient in that not all process conditions that may be detected on the press are associated to the rewind roll for performance metrics or downstream processes, and in that only limited information can be recorded physically on the rewind roll.

In accordance with the embodiments of the present invention, print conditions are tracked in a wound roll after printing for processes downstream from the press and to track print metrics. The conditions tracked can be made known to any downstream process capable of reading the data. The downstream process can then make decisions based on programmed metrics to reject or deliver the print found on the roll by the downstream process or metric review.

The system according to the present invention facilitates passing of process information to downstream processes permitting the downstream process to make quantitative decisions based on conditions recorded during printing and passed on to the downstream process.

The system links print process data known and detected on the press printing roll to roll, to downstream processes which process the wound roll. The press system may be diverse and supplied by multiple vendors but all of the data can be collected and available to the press control system (all process data can be managed in one place). The print process data so collected can be associated to the rewound roll specifically by wound roll length.

Referring to FIG. 1, the system includes a plurality of sensors 80-85 which are located between the unwind roll and the rewind roll, and preferably between the printing units and the rewind roll. The system further includes a controller 1000 which receives data from the sensors.

A position sensor 90 is utilized to track substrate length on to the roll. Rollers 91, 92 and 93 are arranged such that roller 92 operates as a non-slip roller. Examples of position sensors include resolvers and encoders. Position sensor 90 is coupled to roller 92. The signal from position sensor 90 is used by the controller to track the substrate length on the roll. In this regard, the signal from the position sensor is used to divide the web on the roll into plurality of equally spaced apart positions. As an example, if the roller were to have a circumference of 40 mm, and the position sensor is an encoder had a resolution of 2,048 increments per revolution, the system could track to a resolution of 40/2048, or 0.0195 mm, or a plurality of locations spaced apart by 0.0195 mm. However, it should be understood that position sensors can have a lesser or greater resolution, for example, between 90 and 10,000. Moreover, it should be understood that the controller can use only a subset of those sensed positions. For example, it may use only 1024 positions of 2048 positions sensed.

Controller 1000 processes the data from the sensors with the position sensor data to provide, for each sensed position, a set of sensor data. The sensor data may include: register inclusive of lateral register, circumferential register and skew; optical density; grey balance Delta e (color deviation); repeat length; lateral fit; scumming condition; “print does not match master”; water marks; print defects (mark, spot, slim hole, hickey). Data could also be input manually, for example from a visual inspection (True=pass, False=fail, for example). By way of illustration, the controller could store in memory an association between the sensed parameters and positions as follows:

| | | | | | | | Print | | | |
|---|---|---|---|---|---|---|---|---|---|---|
| | Register lateral, | Optical | Color | Repeat | Lateral | | matches | Water | Print | Visual |
| Position | circumf., skew | density | deviation | length | fit | Scumming | master | marks | defect | Inspection |
| (unit) | (inches) | (OD points) | (delta e) | (inches) | (Boolean) | (Boolean) | (Boolean) | (Boolean) | (Boolean) | (Boolean) |
| 1 | 0.002, | 1.2 | 6 | 42.002 | True | True | True | True | True | True |
| | 0.005, | | | | | | | | | |
| | 0.001 | | | | | | | | | |
| . . . | | | | | | | | | | |
| 200 | 0.002, | 1.4 | 4 | 41.003 | False | True | False | True | True | True |
| | 0.005, | | | | | | | | | |
| | 0.010 | | | | | | | | | |
| . . . | | | | | | | | | | |
| 315 | 0.001, | 1.3 | 5 | 42.004 | True | True | True | True | True | True |
| | 0.003, | | | | | | | | | |
| | 0.010 | | | | | | | | | |
| . . . | | | | | | | | | | |
| 403 | 0.001, | 1.2 | 3 | 42.003 | True | False | True | True | False | False |
| | 0.002, | | | | | | | | | |
| | 0.010 | | | | | | | | | |
| . . . | | | | | | | | | | |
| 517 | 0.001, | 1.2 | 3 | 42.010 | True | True | True | False | True | True |
| | 0.003, | | | | | | | | | |
| | 0.010 | | | | | | | | | |
| . . . | | | | | | | | | | |
| 670 | 0.001, | 1.2 | 3 | 42.009 | False | True | False | True | True | True |
| | 0.003, | | | | | | | | | |
| | 0.010 | | | | | | | | | |
| . . . | | | | | | | | | | |
| 1000 | 0.001, | 1.2 | 1 | 42.008 | True | False | True | False | False | False |
| | 0.003, | | | | | | | | | |
| | 0.010 | | | | | | | | | |

In this regard, the position values shown here are merely for illustration, and are not intended to represent actual conditions. It should also be understood that additional processing may also be performed. For example, positions at which the sensed values are within predetermined limits can be omitted. Further, data compression techniques could be used as well.

The techniques for determining from sensor data (i) register inclusive of lateral register, circumferential register and skew; (ii) optical density; (iii) grey balance delta e (color deviation); (iv) repeat length; (v) lateral fit; (vi) scumming condition; (vii) print does not match master; (viii) water marks; (ix) print defects (mark, spot, slim hole, hickey) are known in the art and will not be discussed in detail herein.

However, as a general matter, lateral register, circumferential register, and skew can be determined by sensing and processing register marks with color registration system. Printing plates include register marks which are printed along with, for example, the images that will make up the final printed product. Optical sensors sense register marks which are printed on the web. Deviation of overlayed marks of different printing units indicates lateral register error if in the direction lengthwise across plate cylinder (i.e. perpendicular to web path), circumferential register if in the circumferential direction around plate cylinder (i.e. along or parallel with web path); and skew if deviation is neither parallel nor perpendicular to web path). The optical sensors will typically be located downstream of the dryer in the printing press. The (tensioned) repeat length can also be determined by sensing register marks.

Optical density can be measured with a densitometer located downstream of the dryer. Typically, optical density is defined in Optical Density Points or OD Points. Delta E grey balance is defined as the difference between two colors in an L*a*b* color space. It can also be calculated using sensor data from a densitometer.

The lateral fit is the extent to which the web width matches a target with width at various places along the print press. The web is, at various points, wet, heated, and cooled, and passes through various rollers which can change the width of the web. Lateral fit can be detected with an optical sensor such as a high resolution camera, or with other optical sensors which detect web edges.

Scumming occurs when ink adheres to the non-print areas of lithographic printing plate. It can be detected by processing sensor data from high resolution cameras. Processing data from high resolution cameras also allows determination of whether the print matches the master.

With regard to print defects: (i) a spot defect is a spot on the web, which may be formed during roll manufacture or by liquid condensation during or after roll manufacture; (ii) a mark defect is a mark occurring on the web, for example a mark imparted by rollers contacting the web; (iii) a slime hole defect is a hole in paper, characterized by brownish translucent material around the edges. All of these defects can be detected by processing sensor data from high resolution cameras. Hickey defects and watermarks can also be determined from high resolution cameras.

Controller 1000 may, for example, be a computer or processor with associated memory. It may be dedicated to processing the sensor and position data, or can be part of a larger press control system or part of a press planning system. Controller 1000 could also be implemented without software, for example, via an ASIC, FPGA, or other integrated circuits.

The data collected and associated to the wound roll can be transferred to a physical memory media 35 such as a USB thumb drive, or networked to a central memory location (server or planning system) which can be physically or virtually associated to the wound roll. As a wound roll is unwound in a downstream process data logged to the virtual or physical memory can be unspooled and evaluated.

The roll itself may be identified by means of an RFID tag or by physical means such as marking or barcoding. Roll identification will link the physical roll to the data associated to it. Further, some or all of the sensor and position data itself could be stored on the RFID tag. In other words, media 35 could be memory in an RFID tag.

As described above, the system using an encoder, resolver, or other position sensor to track the length of substrate wound on to each roll and to associate print process defects to the roll by these length markers. The length is used as a marker with each roll to associate process conditions detected by the press control system. The print process conditions and associated length so detected are transferred to a memory device, physical or virtual, that is associated with the physical roll being printed. The downstream process utilizes the length marker in reverse to determine if print defects that may be found within the roll should be processed or rejected.

The roll data can, for example, be maintained on a job planning system such as OmniX. Data on such a system could be made available plant wide or worldwide via the internet if print operations were other than one location.

In addition to print process defects, tracking of process metrics for quality verification may also be recorded and associated to the printed wound roll in the same manner. Data which may be recorded to memory associated with each print roll for quality control purposes includes: Dot gain; Contrast; Register deviation lateral, circumferential, skew; Optical density targets; optical density deviation from target densities; total length of substrate on roll; substrate type, modulus, thickness; Ink key preset metrics (RMS error); Job repeat length; and Unstrained repeat length (measured).

The aforementioned process metrics are well known in the art and will not be described in detail. These metrics can be preset values, or values measured off-line or during make-ready.

For example, contrast can be calculated at make-ready using Color Reflection Spectrodensitometer. Print Contrast indicates the degree to which shadow detail is maintained on the printed substrate. % Print Contrast=((Ds−Dt)/Dt)*100, Where: Ds=Density of solid Dt=Density of tint (typically 75%).

Dot gain is an amount in which dots printed web exceed their target dot size. It is typically expressed as a percent gain over the target size.

Lateral, circumferential, and skew deviation are presets which set the allowable deviation of lateral, circumferential register and skew respectively. Optical density targets are presets which set the target optical density, and the optical density deviation from target densities are presets which set the allowable deviation from target optical density.

The total length of substrate on roll, substrate type, substrate modulus, substrate thickness, and ink key preset metrics (RMS error) are also presets.

The Unstrained repeat length is a measurement of the repeat length on the printed web when not under tension. This can be done manually and input in the system. It can also be calculated during a press run as described in U.S. Ser. No. 13/890,475, filed May 9, 2013, incorporated by reference.

All of this data can be collected by the press control system, processed and formatted so downstream processes may use the data for process control or print performance verification associated with the printed roll from the press.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A method for recording print processing conditions on a printed web of a rewind roll during operation of a printing press to print a print job, comprising:
providing a web roll, the web roll containing a web;
unwinding the web from the web roll and passing the web through a printing unit of the printing press;
printing on the web with the printing unit as the web passes through the printing unit;
passing the web through one or more further processing components to a rewind station located downstream of the downstream of the printing unit;
winding the printed web onto a rewind roll located at the rewind station;
wherein, as the web passes through the one or more further processing components, further performing the steps of:
tracking, with a position sensor, a plurality of equally spaced locations on the web; detecting, using one or more sensors, a plurality printing process parameters of the printing press at a plurality of time points;
and further including the steps of
associating the sensed printing process parameters with the tracked locations on the web at which the printing process parameters were sensed such that, for each tracked location, there is an associated set of printing process parameters;
storing in memory, for each tracked location, the associated set of printing process parameters; and
storing in memory an identification of the rewind roll, and an association of the rewind roll with the associated set of printing process parameters for each tracked location.

2. The method of claim 1, wherein the step of detecting, further comprises using a processor to process data from the one or more sensors to generate one or more of the plurality of printing process parameters.

3. The method of claim 2, wherein the printing process parameters includes two or more of:
a print defect selected from the group consisting of mark, spot, slime hole, and hickeys;
optical density;
registration;
color deviation;
scumming;
lateral fit; and
water mark.

4. The method of claim 2, wherein the printing process parameters include registration, and the registration is one or more of circumferential register, lateral register, and skew.

5. The method of claim 3, where the printing process parameters further include a parameter which indicates whether or not an printed image on the web matches a master image.

6. The method of claim 1, further comprising printing a scanable label, the scanable label having identification information uniquely identifying the rewind roll.

7. The method of claim 1, further comprising
storing in memory, print job data associated with the print job; and
storing in memory, an association of the print job data with the rewind roll.

8. The method of claim 6, wherein the print job data includes two or more of;
dot gain;
contrast;
register deviation;
optical density targets;
optical density deviation limit;
length of web on roll;
substrate type;
substrate modulus;
substrate thickness;
ink key preset metrics;
print job repeat length; and
unstrained repeat length.

9. A printing press, comprising:
a web roll, the web roll containing a web;
an infeed, the infeed configured and arranged to unwind the web from the web roll;
a plurality of printing units configured and arranged to print on the web as the web passes through the printing units;
a rewind station located downstream of the of the printing units, the rewind station configured and arrange to wind the web onto a rewind roll;
one or more further processing components located downstream of the printing units and upstream of the rewind station;
a position sensor, the position sensor configured and arranged to track a plurality of equally spaced locations on the web;
a controller, the controller connected to the infeed, the plurality of printing units, the rewind station, the controller configured and arranged to perform the method of claim 1.

10. The printing press of claim 9, wherein the controller is configured and arranged to perform the method of claim 2.

11. The printing press of claim 9, wherein the controller is configured and arranged to perform the method of claim 3.

12. The printing press of claim 9, wherein the controller is configured and arranged to perform the method of claim 4.

13. The printing press of claim 9, wherein the controller is configured and arranged to perform the method of claim 5.

14. The printing press of claim 9, wherein the controller is configured and arranged to perform the method of claim 6.

15. The printing press of claim 9, wherein the controller is configured and arranged to perform the method of claim 7

16. The printing press of claim 9, wherein the controller is configured and arranged to perform the method of claim 8.
